(19) United States
(12) Patent Application Publication
(10) Pub. No.: US 2017/0031167 A1
(43) Pub. Date: Feb. 2, 2017

(54) Stereoscopic reflector

(71) Applicant: Michael James Baxter, Saint Paul, MN (US)

(72) Inventor: Michael James Baxter, Saint Paul, MN (US)

(21) Appl. No.: 14/756,079

(22) Filed: Jul. 29, 2015

(51) Int. Cl. G02B 27/22

(52) U.S. Cl. CPC G02B 27/22

(57) ABSTRACT

A stereoscopic viewer comprising a plurality of mirrors used to view images in real time.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM COMPACT DISC APPENDIX

Not Applicable

### BACKGROUND OF THE INVENTION

It is well documented that stereoscopes use side by side imaging to produce stereoscopic images. The side by sides include a pair of identical images called stereographs. Stereograph formats include, but are not limited to, photographs, art works, video clips, and computer generated images. The stereograph image pairs are positioned side by side laterally, parallel to the eyes, where each image is aligned with its corresponding eye respectively. When a viewer watches the stereograph through the lenses of a stereoscope, the brain combines the images into a stereoscopic one. Before the viewer can watch the stereographs, the stereographs have to be to be prepared. That preparation time prevents the viewer from watching stereographs in real time. To date, side by side imaging techniques are still employed without change regardless of the content format.

### BRIEF SUMMARY OF THE INVENTION

According to at least one embodiment, the invention uses side by side imaging to produce stereoscopic images. The side by sides include a pair of mirrors that reflect identical images. The mirrors are substitutes for traditional stereographs eliminating the need for them altogether. As a result, the mirrors can reflect among other things, electronic device screens that can be watched in real time. One way to accomplish this is by using a pair of mirrors that are positioned side by side laterally, horizontal to the eyes, where each mirror is aligned with its corresponding eye respectively. When the mirrors are focused on a screen, a viewer can watch stereoscopic images from the surface of the mirrors.

### BRIEF DESCRIPTION OF THE FIGURES

FIG. 1 is a front side view of two circular concave mirrors.

FIG. 2 is a front side view of the two mirrors positioned underneath the eyes.

FIG. 3 is a right side view of the mirrors positioned underneath the eyes and aimed toward the screen of an electronic device.

### DETAILED DESCRIPTION OF THE INVENTION

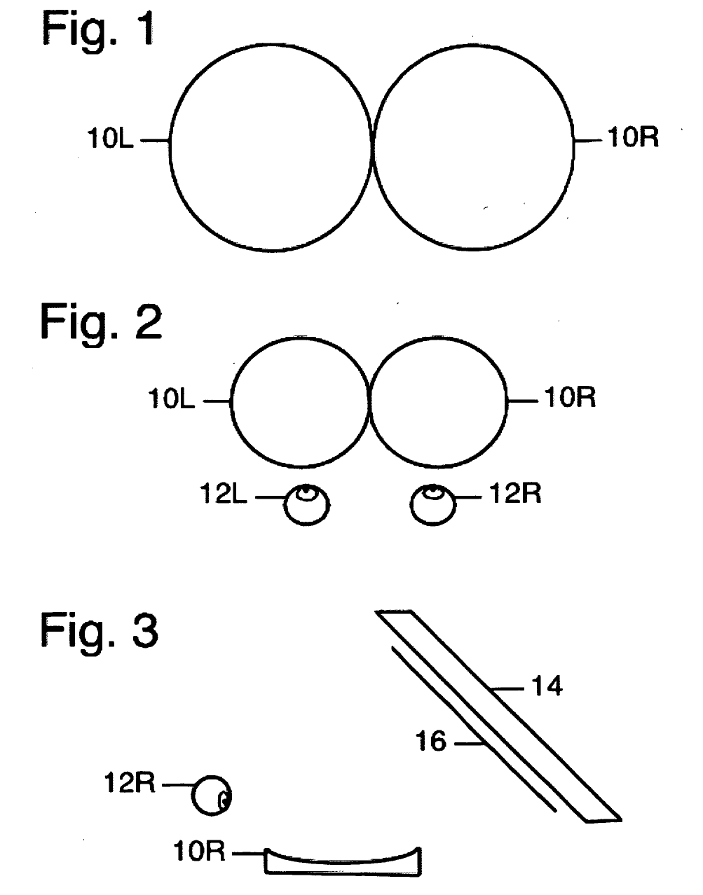

According to at least one embodiment of the invention, FIG. 1 is a front side view that includes, but is not limited to, two concave mirrors 10L and 10R with the concave surfaces facing forward. Each mirror has a diameter of approximately 75 mm with a focal length of 200 mm.

FIG. 2 is a top side view of the two mirrors 10L and 10R positioned relative to the viewer's eyes 12L and 12R. Each mirror is positioned approximately side by side laterally, horizontal to the eyes, with the concave surface facing upward. The mirrors are positioned so that the left mirror 10L is approximately centered underneath the left eye 12L, and the right mirror 10R is approximately centered underneath the right eye 12R.

FIG. 3 is a right side view illustrating the configuration of the mirrors 10R and 10L (not shown) and eyes 12R and 12L (not shown) focused on an electronic device 14 with a display screen 16. The dimensions of the electronic device are approximately 200 millimeters×150 millimeters. However, other dimensions are acceptable. The device is positioned approximately 0.4 meters away with the bottom of the screen at approximately eye level. The device is tilted toward the mirrors at approximately a 45 degree angle.

A viewer takes two mirrors, positions the mirrors underneath the eyes and aims the mirrors toward an electronic device per FIGS. 1-3. The viewer watches the reflected images on the surface of the mirrors. If the mirrors are not aligned with the eyes properly the image will be out of focus and appear as a double image. To align the mirrors with the eyes, the viewer can superimpose the two images one over another by changing the angles of the mirrors slightly. This is done by trial and error. When the mirrors are aligned properly, the viewer will see only one image. The image that is reflected in the mirrors will be inverted, which means the image will be upside down with a backward left right orientation. There are a number of apps and software programs that will correct the inverted image for some viewable content. Otherwise, the electronic device can be positioned upside down relative to normal viewing which will correct the upside down image, but will not correct the backward left-right orientation.

What is claimed is:

1. A stereoscopic reflector for viewing images in real time comprising a plurality of mirrors of a type taken from a group including flat, convex, and concave.
